(19) United States
(12) Patent Application Publication
(10) Pub. No.: US 2025/0048479 A1
(43) Pub. Date: Feb. 6, 2025

(54) Methods and Apparatuses for Operating a Radio Unit During Loss of Connection in a Radio Access Network

(71) Applicant: Telefonaktiebolaget LM Ericsson (publ), Stockholm (SE)

(72) Inventors: Eduardo Lins de Medeiros, Sundbyberg (SE); Per-Erik Eriksson, Stockholm (SE); Igor Almeida, Indaiatuba-SP (BR); Gyanesh Patra, Santa Clara, CA (US)

(21) Appl. No.: 18/715,259

(22) PCT Filed: Dec. 17, 2021
(86) PCT No.: PCT/SE2021/051285

§ 371 Date: May 31, 2024

(51) Int. Cl. H04W 76/25; H04W 24/04

(52) U.S. Cl. CPC H04W 76/25; H04W 24/04

(57) ABSTRACT

Techniques are described for mitigating the negative effects of temporary loss of connectivity or temporary loss of service between a RU and a BU. In embodiments of the present disclosure, the radio unit is configured to transmit reference signals during a temporary loss of connectivity with the baseband unit to allow the UEs served by the radio unit to maintain synchronization with the radio unit and avoid or minimize radio link failures. Applying these techniques, the UEs served by the radio unit can maintain connection with the radio unit during the temporary outage and avoid the need to engage in Radio Resource Control (RRC) signaling to re-establish a connection with the radio unit and/or handover to neighboring radio units.

### TECHNICAL FIELD

The present disclosure relates generally to a radio access network and, more particularly, to an autonomous operating mode for a radio unit (40, 600) responsive to loss of connectivity or loss of service with a baseband unit (30, 700).

### BACKGROUND

It is known to separate the functions of a base station in a 5th Generation (5G) network into two parts: a radio unit (RU) and a baseband unit (BU). The RU serves as the radio part of the base station, also known as a 5G NodeB (gNB), and contains the radio frequency (RF) circuitry and antennas for transmitting signals to and receiving signals from user equipment (UEs) served by the base station. The BU serves as the control part of the base station. The BU processes signals transmitted and received by the base station and handles most control functions, such as scheduling, resource allocation, power control, etc. In this split architecture, the BUs can be pooled and shared by multiple RUs.

The physical separation between RU and BU can be advantageous for many reasons. For example, the RU and BU may have different life cycles (e.g., RUs can be in service for longer than BUs) and/or different upgrade cycles (e.g., upgrades of BUs may be more frequent while keeping radio in original state). Additionally, separating the RU and BU provides flexibility in deployment (e.g., smaller radios are easier to deploy). In a Centralized RAN (C-RAN), the BU is geographically separated from the RU and may be part of a pool of BUs shared between RUs.

Cloud Radio Access Network (RAN) is a new architecture for RANs where the certain RAN functions (e.g., the BU) are moved into the cloud and realized using commercial-off-the-shelf (COTS) hardware. Separation of the BU into two logical units known as the Central Unit (CU) and the Distributed Unit (DU) with a well-defined interface (F1) was standardized by the Third Generation Partnership Project (3GPP) in Release 15 (R15) of the 5G standard. The CU—with less stringent processing requirements—is generally considered to be more amenable to virtualization than the DU, whose functions are closer to the radio. For full-stack RAN virtualization, the DU is connected to the RU via a packet interface known as enhanced Common Public Radio Interface (eCPRI).

In the Cloud RAN architecture, there are multiple ways to divide functions between the DU and the RU, which are referred to as lower-layer split (LLS) options. One possible alternative specified by the Open RAN (O-RAN) Alliance is referred to as the 7-2x split, but other functional splits are also being considered. In recent years, the trend toward the split architecture for the base station has accelerated, with more functionalities being added to RUs.

The trend toward virtualization of the BU means that many of the Layer 1 (L1) and Layer 2 (L2) functions will be implemented in a distributed fashion, which increases the probability of connectivity errors that result in temporary loss of connectivity or temporary loss of service between the RU and BU. These events can occur if the connectivity between nodes is interrupted due, for example, to changes in routing path, fiber bends, dirty connectors in transceivers, bad atmospheric conditions or mast sway in microwave links, physical obstructions, or interference in self-backhauled systems such as an Integrated Access and Backhaul (IAB). In the case of virtualized BUs (vBUs), temporary outages may occur when the underlying computational resources are overloaded or badly dimensioned. Additionally, temporary outages may occur when vBU instances (or vBU components) are being migrated between servers, when a software crash has occurred, or while waiting for a vBU instance to be (re) initialized.

Traditionally, events causing loss of connectivity between the RU and BU lead to one or more cells served by the affected nodes being “locked”. When a cell is locked, service to UEs served by the cell is interrupted. Methods to avoid cell locking include redundant backhaul/fronthaul links, redundant optical modules, automatic protection switching, and optical rings. These measures focus on maintaining or restoring connectivity between nodes as quickly as possible.

Loss of service due to hardware and software failures in a node can be dealt with using some form of monitoring and automatic restarting procedures. An example of these techniques includes the use of hardware watchdog timers that may reboot a host or service in case inactivity or lack of responses are detected and exceed a time threshold. In virtualized environments, pods or virtual machines (VMs) may be restarted automatically using policies implemented by a hypervisor or container management environment (e.g., Kubernetes).

The existing methods for dealing with loss of connectivity and loss of service that rely on locking the status of a cell (resulting in loss of service between RU and UEs) may be costly in terms of requiring a full cell (re) start. When such an event occurs, each UE in the coverage area must reattach and perform Radio Resource Control (RRC) signaling to re-establish connectivity or handover, which can result in a large spike in signaling depending on the number of users affected.

The conventional methods also do not cover outages or lack of availability caused by faults inherent to a virtualized environment used by Cloud RAN products. For example, lack of service may be caused by container resource management/hypervisor actions.

### SUMMARY

The present disclosure relates to techniques for mitigating the negative effects of a temporary loss of connectivity or temporary loss of service between a RU and a BU. In embodiments of the present disclosure, the RU is configured to transmit reference signals during a temporary loss of connectivity with the BU to allow the UEs served by the RU to maintain synchronization with the RU and avoid or minimize radio link failures. Applying these techniques, the UEs served by the RU can maintain connection with the RU during the temporary outage and avoid the need to engage in RRC signaling to re-establish a connection with the RU and/or handover to neighboring RUs.

The first aspect of the disclosure comprises methods of operating a RU in a wireless communication network configured to transmit references signals during temporary loss of connectivity with the BU. In one embodiment, the method comprises detecting an indication of actual or potential loss of connectivity between the RU and a BU and, responsive to the indication, transmitting reference signals during the loss of connectivity to maintain connection with one or more UEs served by the RU during the loss of connectivity with the BU.

A second aspect of the disclosure comprises a RU in a wireless communication network configured to transmit references signals during temporary loss of connectivity with the BU. In one embodiment, the RU is configured to detect an indication of actual or potential loss of connectivity between the RU and a BU and, responsive to the indication, transmit reference signals during the loss of connectivity to maintain connection with one or more UEs served by the RU during the loss of connectivity with the BU.

A third aspect of the disclosure comprises a RU in a wireless communication network configured to transmit references signals during temporary loss of connectivity with the BU. The RU comprises communication circuitry for communicating with a BU over a fronthaul interface and processing circuitry. The processing circuitry is configured to detect an indication of actual or potential loss of connectivity between the RU and a BU and, responsive to the indication, transmit reference signals during the loss of connectivity to maintain connection with one or more UEs served by the RU during the loss of connectivity with the BU.

A fourth aspect of the disclosure comprises computer programs comprising executable instructions that, when executed by a processing circuit in a RU in a wireless communication network, causes the RU to perform any one of the methods according to the first aspect.

A fifth aspect of the disclosure comprises a carrier containing a computer program according to the fourth aspect, wherein the carrier is one of an electronic signal, optical signal, radio signal, or computer readable storage medium.

A sixth aspect of the disclosure comprises methods of operating a BU in a wireless communication network configured to mitigate loss of connectivity with a RU. In one embodiment, the method comprises configuring the RU to transmit reference signals during a temporary loss of connectivity between the BU and a RU, interrupting communications with the RU during the temporary loss of connectivity between the BU and a RU, and resuming communication with the RU when connectivity with the RU is re-established.

A seventh aspect of the disclosure comprises a BU in a wireless communication network configured to mitigate loss of connectivity with a RU. In one embodiment the BU is configured to configure the RU to transmit reference signals during a temporary loss of connectivity between the BU and a RU, interrupt communications with the RU during the temporary loss of connectivity between the BU and a RU, and resume communication with the RU when connectivity with the RU is re-established.

An eighth aspect of the disclosure comprises a BU in a wireless communication network configured to mitigate loss of connectivity with a RU. The BU comprises communication circuitry for communicating with a RU over a fronthaul interface and processing circuitry. The processing circuitry is configured to configure the RU to transmit reference signals during a temporary loss of connectivity between the BU and a RU, interrupt communications with the RU during the temporary loss of connectivity between the BU and a RU, and resume communication with the RU when connectivity with the RU is re-established.

A ninth aspect of the disclosure comprises computer programs comprising executable instructions that, when executed by a processing circuit in a BU in a wireless communication network, causes the BU to perform any one of the method according to the sixth aspect.

A tenth aspect of the disclosure comprises a carrier containing a computer program according to the ninth aspect, wherein the carrier is one of an electronic signal, optical signal, radio signal, or computer readable storage medium.

### BRIEF DESCRIPTION OF THE DRAWINGS

FIG. 1 illustrates a wireless communication network with a radio access network (RAN).

FIG. 2 illustrates exemplary a finite state machine for a RU in a RAN including an autonomous state.

FIG. 3 illustrates exemplary a finite state machine for a RU in a RAN including a detached and controlled outage states.

FIG. 4 illustrates an exemplary outage procedure implemented by a RU during loss of connectivity with a BU.

FIG. 5 illustrates an exemplary controlled outage procedure implemented by a BU during a controlled outage period.

FIG. 6 illustrates an exemplary unplanned outage procedure implemented by a BU for mitigating loss of connectivity with a RU during an unplanned outage.

FIG. 7 illustrates an exemplary method implemented by a RU during loss of connectivity with a BU.

FIG. 8 illustrates an exemplary method implemented by a BU during loss of connectivity with a RU.

FIG. 9 illustrates an exemplary RU configured to transmit reference signals during a loss of connectivity with a BU.

FIG. 10 illustrates an exemplary BU configured to mitigate loss of connectivity with a RU.

FIG. 11 illustrates an exemplary RU configured to transmit reference signals during a loss of connectivity with a BU.

FIG. 12 illustrates an exemplary BU configured to mitigate loss of connectivity with a RU.

FIG. 13 is a schematic block diagram illustrating an example wireless network, according to particular embodiments of the present disclosure.

FIG. 14 is a schematic block diagram illustrating an example of a user equipment, according to particular embodiments of the present disclosure.

FIG. 15 is a schematic block diagram illustrating an example of a virtualization environment, according to particular embodiments of the present disclosure.

FIG. 16 is a schematic illustrating an example telecommunication network, according to particular embodiments of the present disclosure.

FIG. 17 is a schematic block diagram illustrating an example communication system, according to particular embodiments of the present disclosure.

FIGS. 18-21 are flow diagrams, each of which illustrates an example method implemented in a communication system, according to particular embodiments of the present disclosure.

### DETAILED DESCRIPTION

The present disclosure relates to techniques for mitigating the negative effects of a temporary loss of connectivity or temporary loss of service between a RU and a BU in a C-RAN or Cloud RAN. In embodiments of the present disclosure, the RU in the RAN is configured to transmit reference signals during a temporary loss of connectivity with the BU to allow the UEs served by the RU to maintain synchronization with the RU and avoid or minimize radio link failures. Applying these techniques, the UEs served by the RU can maintain connection with the RU during the temporary outage and avoid the need to engage in Radio Resource Control (RRC) signaling to re-establish a connection with the RU and/or handover to neighboring RUs.

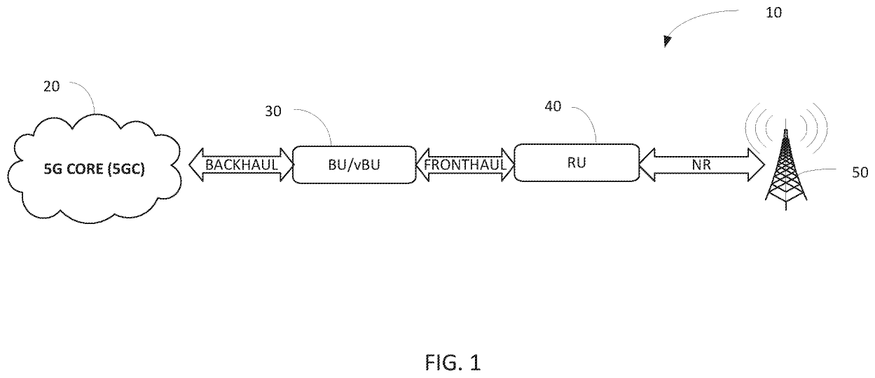

FIG. 1 illustrates a wireless communication network 10 with a RAN configured to operate according to Fifth Generation (5G) standards developed by 3GPP. Those skilled in the art will appreciate, however, that the techniques herein described can be applied in networks operating according to the Long Term Evolution (LTE) standard or other standards now known or later developed. More generally, the techniques herein described can be used in any wireless communication network 10 with a RAN where the RU and BU are logically separated.

The wireless communication network 10 comprises a core network (CN) 20, one or more BUs 30, and one or more RUs 40. Each RU 40 is connected to one or more antennas 50. A pairing between a BU 30 and RU 40 collectively forms a base station, which is also known as an 5G NodeB (gNB) in 3GPP standards. The RU 40 serves as the radio part of the base station and contains the radio frequency (RF) circuitry for transmitting signals to and receiving signals from UEs served by the base station. The BU 30 serves as the control part of the base station. The BU 30 processes signals transmitted and received by the base station and handles most control functions, such as scheduling, power control, etc. In this split architecture, the BUs 30 can be pooled and shared by multiple RUs 40.

The physical separation between RU 40 and BU 30 can be advantageous for many reasons. For example, the RU 40 and BU 30 may have different life cycles and/or different upgrade cycles. Additionally, separating the RU 40 and BU 30 provides flexibility in deployment (e.g., smaller radios are easier to deploy). The BU 30 may be implemented on proprietary hardware or may be cloud-native (implemented in a VM or container on COTS hardware). In either case, there is a potential for temporary loss of connectivity between the RU 40 and BU 30. The loss of connectivity may be unplanned (e.g., link failure, hardware failure, or software crash) or planned (e.g., software upgrade or reconfiguration).

Traditionally, events causing loss of connectivity between the RU 40 and BU 30 lead to one or more cells served by the affected RUs 40 being “locked”. When the cell is locked, the UEs served by the cell perform RRC signaling to re-establish connection with the network. The RRC signaling due to cell locking increases the signaling overhead in the network and reduces network efficiency. Additionally, cell locking can result in a spike in RRC signaling depending on the number of affected UEs.

One aspect of the present disclosure is to avoid cell locking and concomitant increase in RRC signaling when the RU 40 loses connectivity with BU 30 for relatively short time periods of up to a few seconds. This is achieved by introducing the concept of an autonomous mode for the RU 40 in which the RU 40 continues to transmit reference signals to the UEs during a temporary loss of connectivity with the BU 30. By transmitting the reference signals during the loss connectivity, the UEs served by the RU 40 are able to acquire an/or maintain synchronization with the RU 40 so that RRC signaling to re-establish a connection is avoided. The techniques can be used for both planned outages and unplanned outages, also referred to respectively as controlled outages and uncontrolled outages.

Controlled outages are typically the result of actions taken by the BU 30 and the outage duration is bounded (e.g., BU 30 will be unavailable for 10 seconds). For this category, it is assumed that the BU 30 or its underlying virtualization environment if applicable can signal to the RU 40 to indicate that the outage will occur and optionally provide side information, e.g., including the duration of the outage event. The need for controlled outages can arise in many scenarios. A few non-limiting examples of controlled outages include:
Another instance of a BU 30 will take over the processing of the cells being served by a RU 40.
A virtual machine or container executing a subset of the functionality of a vBU instance needs to be restarted for proper resource allocation by its underlying hypervisor or container management system (e.g., Kubernetes).
A virtual machine or container executing a subset of the functionality of a vBU instance needs to be relocated to another execution environment (e.g., a different server or datacenter).
A hardware module or subsystem used by the vBU needs to be restarted (e.g., an optical module) to reestablish proper operation.
A BU 30 needs to sleep or go into power saving mode for a fixed interval due to thermal alarms.

Uncontrolled outages occur when the outage is not under the control of any of the network nodes and the outage duration is unclear. Non-limiting examples include:
A software crash in a RU 40 or BU 30 or intermediary nodes (e.g., transport network, fronthaul switches).
A hardware failure in RU 40 or BU 30 or intermediary nodes (e.g., transport network, fronthaul switches
Loss of signal between RU 40 and BU 30 due to fiber bends, dirty connectors in transceivers, bad atmospheric conditions or mast sway in microwave links, physical obstructions, or interference in self-backhauled systems.

In exemplary embodiments of the present disclosure, a new RRC state for the RU 40 referred to herein as the autonomous state is introduced. The RU 40 is configured to transition to the autonomous state when connectivity with the BU 30 is lost. In the autonomous state, the RU 40 can transmit reference signals to the UEs in the cells served by the RU 40 and perform limited actions to maintain connection with the UEs. Corresponding states, referred to as the detached state and controlled outage state are defined for the BU 30.

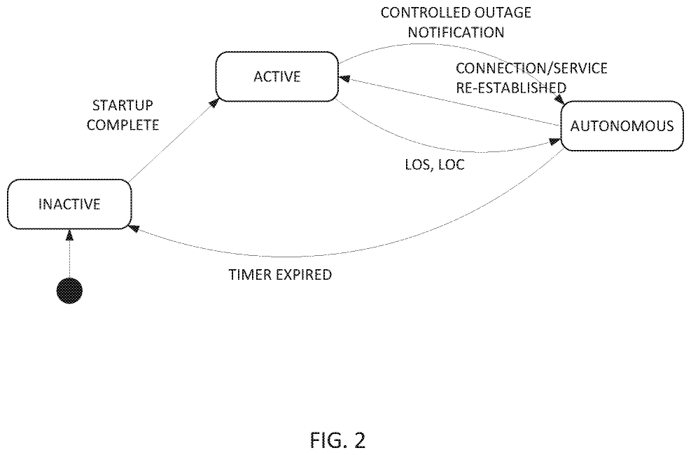

FIG. 2 illustrates an exemplary a finite state machine for a RU 40 in a RAN illustrating the RU states according to one embodiment. In this embodiment, three states after defined for the RU 40: the active state, the inactive state, and the autonomous state. The active state is the normal operating state for the RU 40. In the active state, the RU 40 is “live” and can communicate with UEs operating within cells served by the RU 40. The RU 40 may enter the inactive state in order to reduce power consumption when there are no UEs to serve, for maintenance (e.g., software upgrades and reconfiguration), or due to a hardware or software failure. In the inactive state, the RU 40 is not available to the UEs. The autonomous state is defined as an intermediate state between the active state and the inactive state for scenarios when there is a temporary loss of connectivity with the BU 30. The RU 40 transitions to the autonomous state when it detects a loss of connectivity or loss of service with the BU 30, or when it receives a controlled outage notification from the BU 30 or other network node as hereinafter described. In the latter case, the BU 30 or other network node may provide side information to indicate the duration of the outage. In the autonomous state, the RU 40 continues reference signal transmission to the UEs to enable the UEs to maintain time/frequency synchronization with the cells served by the RU 40 and avoid triggering radio link failure (RLF) at the UEs. Transmission of the reference signals also allows the UEs to maintain the RRC connected state so that RRC signaling and handovers by the UEs are reduced. Reference signals transmitted in the autonomous state can include channel state information reference signals (CSI-RS), primary synchronization signal (PSS) secondary synchronization signal (SSS), master information block (MIB) and other reference signals that are result of deterministic operations (e.g., Zadoff-Chu sequences or Gold sequences) on simple quantities, such as system frame number (SFN) and/or cell identity (Cell ID).

In some embodiments, the RU 40 starts a timer when it enters the autonomous state. For an unplanned outage, an uncontrolled outage timer may be predefined or configured by the BU 30 when the RU 40 is in the active state. For a planned outage, a controlled outage timer can be set based on the side information transmitted in the controlled outage notification. If the outage timer expires before connectivity with the BU 30 is re-established, the RU 40 transitions to the inactive state. If connectivity with the BU 30 is re-established before the outage timer expires, the timer is stopped and the RU 40 returns to the active state.

In addition to reference signal transmission, the RU 40 may buffer PRACH resources, and/or buffer PUSCH an PUCCH resources. If buffering is implemented in the RU 40 and the outage is short, the RU 40 can transmit the buffer contents on connection reestablishment, mitigating these side effects. In some embodiments, the RU 40 may partially or fully decode some channels (e.g., PUCCH, PUSCH) and buffer the result. If the RU can perform PRACH processing and buffering, it could avoid denying service for many UEs (if the outage is short enough).

In some embodiments, the RU 40 is configured to gradually or incrementally decrease the transmit power of the reference signals during the outage period. For example, the RU 40 can be configured to start transmit power reduction when the timer reaches 50%. Reducing the transmit power will result in some UEs (e.g., those on the cell edge) handing over to a neighboring cell. In the case of a planned outage, the controlled outage notification may include side information to control the handover.

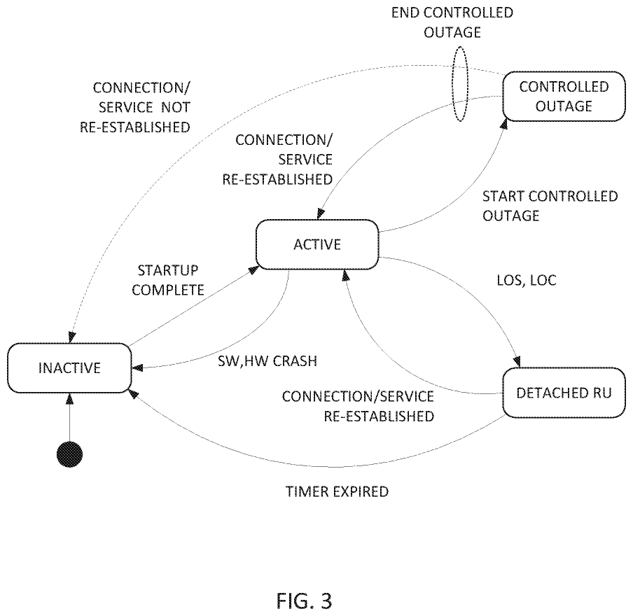

FIG. 3 illustrates exemplary a corresponding finite state machine for the BU 30. In this embodiment, four states are defined for the BU 30: the active state, the inactive state, the detached state and the controlled outage state. The active state is the normal operating state for the BU 30. In the active state, the BU 30 can communicate with the RUs 40 in the RAN over the fronthaul interface. The BU 30 may enter the inactive state in order to reduce power consumption when there are no UEs to serve, for maintenance (e.g., software upgrades and reconfiguration), or due to a hardware or software failure. In the inactive state, the BU 30 is not available to the RUs 40 (and their associated UEs). The detached state and controlled outage states generally correspond to the autonomous state at the RU 40 for unplanned and planned outages, respectively.

The controlled outage state is entered into in the case of a planned outage. Before discussing the BU behavior in the controlled outage state, it is important to reiterate the temporary nature of the outages contemplated in the embodiments of the present disclosure as well as call attention to UE behavior during regular operation. Several conditions can trigger a radio link failure (RLF) procedure, including (a) loss of downlink synchronization, (b) a maximum number of random-access attempts is reached, or (c) a maximum number of HARQ retransmissions is reached. While transmitting reference signals helps prevent (a), only a more robust autonomous RU 40, e.g., one capable of processing PRACH, will help with the prevention of (b). With this in mind, the decision to initiate a controlled outage by the BU 30 should consider the fact that some UEs in the cell might attempt a reestablishment procedure.

As an illustration of the factors to consider in determining whether to declare a controlled outage, the number of random-access attempts can range from 3 to 200, with backoffs in the order of milliseconds, which signifies an interval spanning from possibly the next subframe to several of seconds in the future where reestablishment has not yet occurred. This should be contrasted with the time required for handover to a neighbor cell, which is around 100 milliseconds. Thus, the cost of the interruption to those UEs should be weighed against the cost of shutting down the cell and initiating handovers to neighboring cell, as well as their eventual handover back to the current cell, once it is fully functional.

Having decided that forcing a handover of all UEs and shutting down the cell is more costly (in service time and/or Xn interface bandwidth) than maintaining the reference signals and making UEs cope with non-responsive upper layers, the BU 30 can prepare for the controlled outage. At the start of the controlled outage, the BU 30 sends a controlled outage notification to the RUs 40 supported by the BU 30. The controlled outage notification may include enabling the “cellBarred” parameter in the MIB. The controlled outage notification may include side information, such as the duration of the controlled outage period. In an exemplary embodiment, the controlled outage includes a timer value for the outage timer at the RU 40. Once the controlled outage notification is sent, the BU 30 should not send any new uplink grants and/or downlink assignments, apart from any ongoing HARQ processes. Optionally, the BU 30 may wait for the ongoing HARQ processes to be completed prior to becoming unavailable. At the end of the controlled outage period, the BU 30 returns to the active state, re-establishes communications (e.g., fronthaul, user-plane transmissions, etc.), and resumes transmissions from the current NodeB frame number (BFN). Generally, the controlled outage period is predefined and bounded by an outage timer. The controlled outage period ends when the outage timer expires or the reason for the controlled outage is resolved. If the BU 30 is unable to return to the active state because the connection or service is not re-established, the BU 30 should enter the inactive state.

In embodiments where reference signal generation and transmission are performed by the BU 30, the BU 30 stops generating and sending reference signals during the controlled outage state. In this case, the BU 30 is configured to resume reference signal generation and transmission after returning to the active state (e.g., upon expiration of the controlled outage timer).

The detached state is entered when the BU 30 detects loss of connectivity with an RU 40. Upon detecting the outage, the BU 30 enters the detached state and starts a limit outage timer with a preconfigured value. The limit outage timer value may be derived, for example, from the synchronization holdover performance in the system. In the detached state, the BU 30 interrupts communications towards the RU 40, which can include both fronthaul control data and user plane data. If connectivity is restored before the limit outage timer expires, the BU 30 resumes transmission from the current BFN. If the limit outage timer expires before connectivity is restored, the BU 30 triggers an alarm, locks the cells served by the RU 40, and enters the inactive state.

If the outage is due to a failure of the BU 30 (e.g., hardware failure or software crash), the BU hardware can be configured to send a dying gasp notification to the RUs 40 supported by the BU 30. In the case of a virtualized BU 30, the hypervisor or container management platform can send the dying gasp notification to the RUs 30. Sending a dying gasp notification allows the RUs 40 to enter autonomous state based on the notification, which can be beneficial if the outage is short.

In embodiments where reference signal generation and transmission are performed by the BU 30, the BU 30 stops generating and sending reference signals during the detached state. In this case, the BU 30 is configured to resume reference signal generation and transmission after returning to the active state (e.g., upon expiration of the limit outage timer).

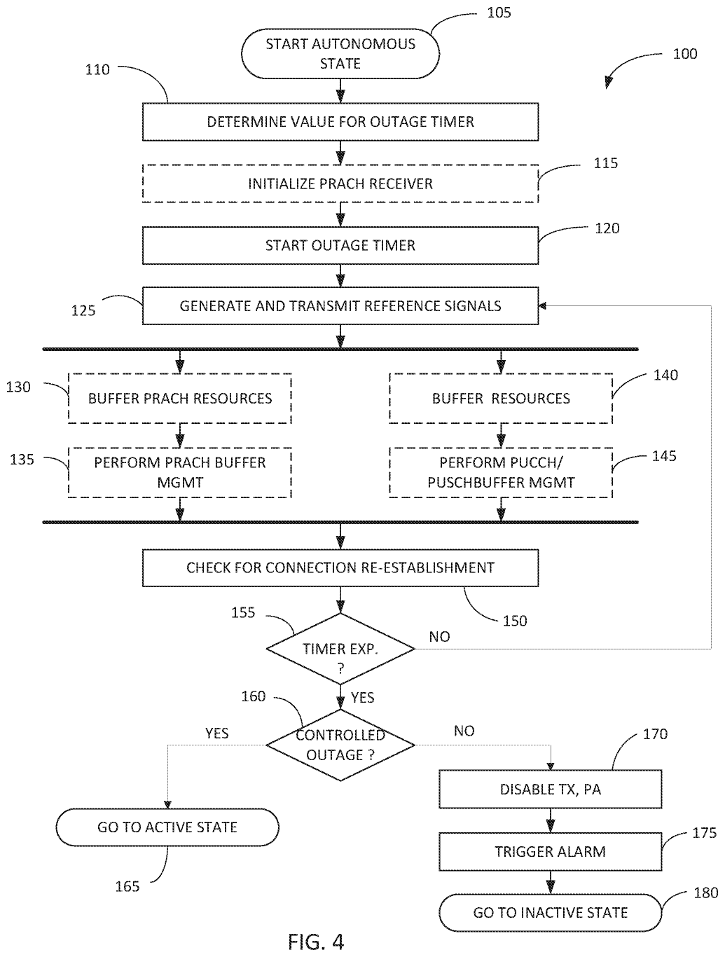

FIG. 4 illustrates an exemplary outage procedure 100 implemented by a RU 40 during loss of connectivity with the BU 30. When the procedure is triggered, the RU 40 enters the autonomous state as previously described (block 105). The procedure 100 can be triggered when the RU 40 detects loss of connectivity or loss of service. The procedure can also be triggered when the RU 40 receives a controlled outage notification from the BU 30. In either case, the RU 40 determines the value of the outage timer responsive to the triggering of the outage procedure (block 110). For unplanned outages, the RU 40 may be preconfigured with a limit outage timer value. For planned outages, the controlled outage timer value can be preconfigured or included in the controlled outage notification. The RU 40 may use a single timer for both planned and unplanned outages, which can be set to different expiration times depending on the type of outage, or separate timers. In some embodiments, the RU 40 may optionally initialize a PRACH receiver for receiving PRACH resources during the outage period (block 115). The RU 40 starts the outage timer using the value determined upon entry into the autonomous state (block 120).

During the outage, the RU 40 generates and transmits reference signals, such as CSI-RS, PSS, SSS and/or MIB (block 125). Some reference signals may be generated by the RU 40 in both the active state and autonomous state. In this case, the RU 40 continues generation and transmission of the reference signals during the outage. In other embodiments, the reference signals may be generated by the BU 30 in the active state and transmitted to the RU 40 over the fronthaul interface. In this case, the RU 40 initiates reference signal generation upon entry into the autonomous state and continues reference signal transmission to the UEs in the cells served by the RU 40.

In some embodiments, the RU 40 may be optionally configured to buffer the PRACH resources (block 130). In this case, the RU 40 performs PRACH buffer management (block 135). Since buffer space is at a premium, the RU 40 may discard older information or stale or expired PRACH attempts that did not receive a response from the BU 30 in the required time.

In some embodiments, the RU 40 may be optionally configured to decode and buffer the PUCCH and/or PUSCH resources (block 140). In this case, the RU 40 performs buffer PUCCH/PUSCH management (block 145). Due to limited buffer space, the RU 40 may discard older information or retransmission attempts from the same UE.

In the case of an unplanned outage, the RU 40 may periodically check for re-establishment of connectivity while in the autonomous state (block 150). This step can be omitted in the case of a planned outage but could also be performed in some embodiments.

While in the autonomous state, the RU 40 monitors the outage timer (e.g., controlled outage timer or limit outage timer) while performing reference signal transmission and, if applicable, buffering of uplink signals (block 155). The process flow branches depended on the type of outage (block 160). In the case of a controlled outage timer, the RU 40 returns to the active state (block 165). In the case of an unplanned outage, the RU 40 disables the transmitter and power amplifier (block 170), triggers an alarm (block 175), and enters the inactive state (block 180).

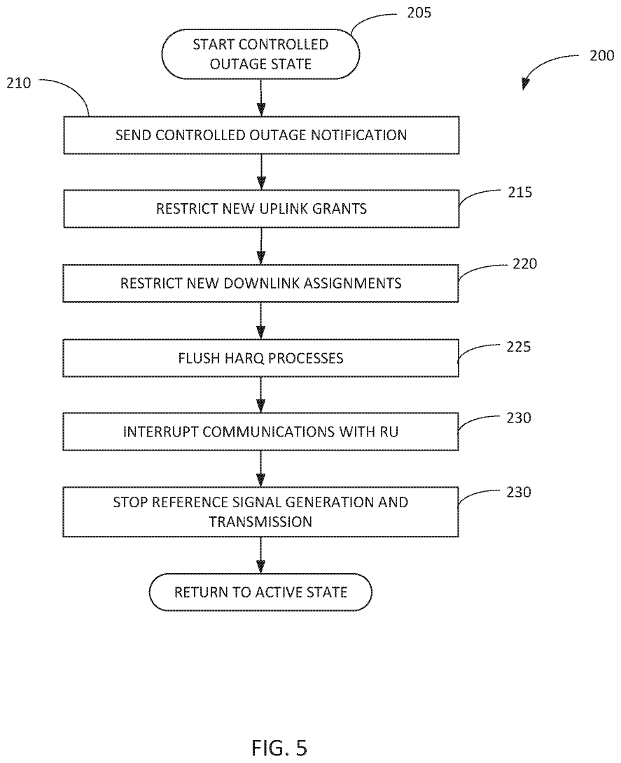

FIG. 5 illustrates an exemplary controlled outage procedure implemented by a BU 30. The procedure begins when the BU 30 determines a need to perform a controlled outage (block 205). When the controlled outage procedure is triggered, the BU 30 enters the controlled outage state as previously described and sends a controlled outage notification to the affected RUs 40 (block 210). During the controlled outage procedure, the BU 30 restricts new uplink grants to UEs in the cells served by the affected RUs 40 (block 215). The BU 30 also restricts new downlink assignments to UEs in the cells served by the affected RUs 40 (block 220). In some embodiments, the BU 30 may optionally complete any ongoing HARQ processes after sending the controlled outage notification (block 225). In this case, the BU 30 waits to interrupt communications with the RU until the HARQ processes are flushed or until some other condition is met. When the HARQ process are flushed, or other required conditions are met, the BU 30 interrupts all communications with the affected RUs 40 (block 230). In other embodiments, the BU 30 may interrupt communications with the affected RUs 40 immediately after sending the controlled outage notification, or some predetermined time period after sending the controlled outage notification (block 230). In embodiments where reference signal generation and transmission is performed by the BU 30 in the active state, the BU 30 stops generating and sending reference signals during the controlled outage state (block 235). When the predetermined controlled outage period ends, the BU 30 returns to the active state (block 240). In embodiments where reference signal generation and transmission is performed by the BU 30 in the active state, the BU 30 resumes generating and sending reference signals after entering the active state.

In some embodiments, reason for the controlled outage may be resolved, e.g., a new instance of BU 30 in a VM is installed, before the outage timer expires. Usually there will be an upper bound in how long this may take, but there is also the possibility that the problem is solved/completed before the upper bound time is reached. In this situation, the BU 30 can be configured to immediately return to the active state without waiting for timer expiration.

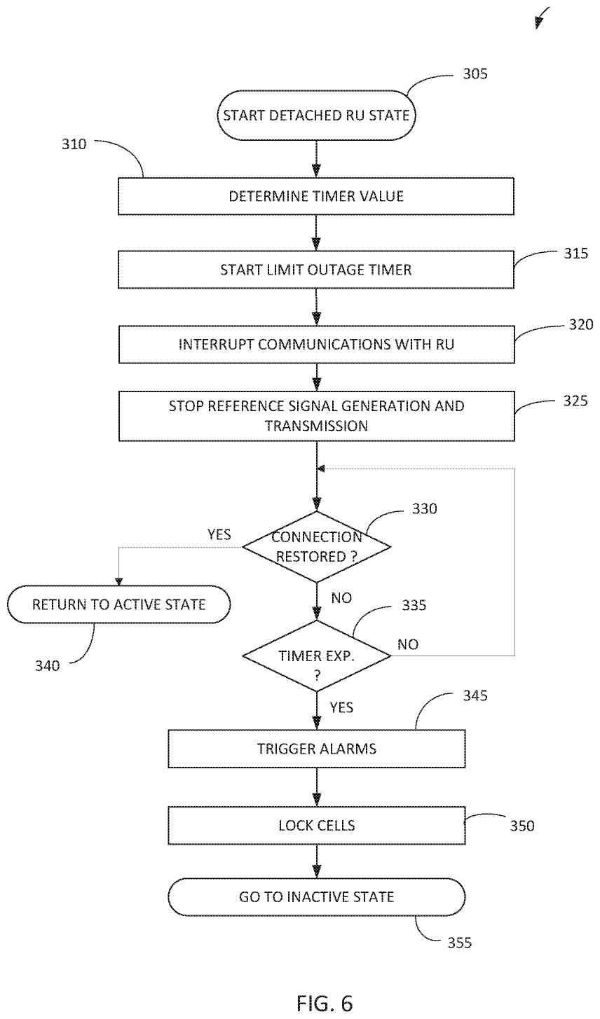

FIG. 6 illustrates an unplanned outage procedure implemented by a BU 30 for mitigating loss of connectivity with a radio unit during an unplanned outage. The procedure begins when the BU 30 detects loss of connectivity with the RU 40 (block 305). When the unplanned outage procedure is triggered, the BU 30 enters the detached state as previously described and determines the value of the limit outage timer (block 310). The BU 30 starts the limit outage timer (block 315) and interrupts communication with the affected RUs 40 (block 320). In embodiments where reference signal generation and transmission are performed by the BU 30 in the active state, the BU 30 stops generating and sending reference signals during the detached state (block 325). While in the detached state, the BU 30 checks for connection re-establishment (block 325) and monitors the limit outage timer (block 335). If connectivity is re-established, the BU 30 returns to the active state (block 340). In embodiments where reference signal generation and transmission are performed by the BU 30 in the active state, the BU 30 resumes generating and sending reference signals after entering the active state. If the limit outage timer expires before connectivity is re-established, the BU 30 triggers an alarm to notify the network operator (block 345), locks the cells served by the affected RUs 40 (block 350), and (if not serving other RUs 40) enters the inactive state (block 355).

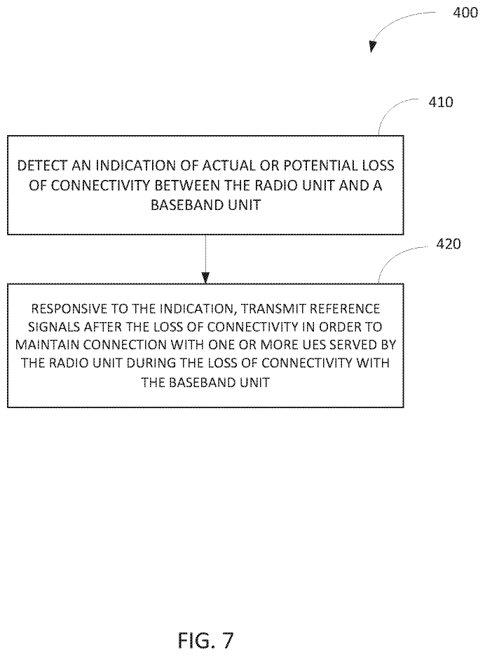

FIG. 7 illustrates an exemplary method 400 of operating a RU 40 in a wireless communication network 10. The RU 40 detects an indication of actual or potential loss of connectivity between the RU 40 and the BU 30 (block 410). Responsive to the indication, the RU 40 transmits reference signals after the loss of connectivity in order to maintain connection with one or more UEs served by the RU 40 during the loss of connectivity with the BU 30 (block 420).

In some embodiments of the method 400, detecting the indication comprises detecting an unplanned loss of connectivity with the BU 30.

Some embodiments of the method 400 further comprise generating the reference signals until connectivity with the BU 30 is re-established.

Some embodiments of the method 400 further comprise initiating an outage timer responsive to the unplanned loss of connectivity and generating the reference signals until the outage timer expires.

In some embodiments of the method 400, a time limit for the outage timer is set according to a time value received from the BU 30 prior to the unplanned outage.

In some embodiments of the method 400, detecting a time limit for the outage timer is set according to a predetermined time value.

In some embodiments of the method 400, the indication is received in a control message prior to a planned loss of connectivity with the BU 30.

Some embodiments of the method 400 further comprise initiating an outage timer responsive to the control message and generating the reference signals until the outage timer expires.

In some embodiments of the method 400, the control message further includes a time value indicating a length of the planned loss of connectivity, and wherein the outage timer is set according to the time value received in the control message.

In some embodiments of the method 400, the outage timer is set according to a predetermined time value.

Some embodiments of the method 400 further comprise storing decoded PRACH signals in a PRACH buffer.

Some embodiments of the method 400 further comprise managing the PRACH buffer during the loss of connectivity.

Some embodiments of the method 400 further comprise storing PUCCH signals in a PUCCH buffer. The PUCCH signals may comprise raw PUCCH signals. Alternatively, the RU may partially or fully decode the PUCCH signals and store the results.

Some embodiments of the method 400 further comprise managing the PUCCH buffer during the loss of connectivity.

Some embodiments of the method 400 further storing PUSCH signals in a PUSCH buffer. The PUCCH signals may comprise raw PUSCH signals. Alternatively, the RU may partially or fully decode the PUSCH signals and store the results.

Some embodiments of the method 400 further comprise managing the PUSCH buffer during the loss of connectivity.

Some embodiments of the method 400 further comprise stopping transmission of reference signals responsive to expiration of the outage timer.

Some embodiments of the method 400 further comprise stopping generation of the reference signals if connection with the BU 30 is re-established.

Some embodiments of the method 400 further comprise decreasing transmit power of the reference signals during the loss of connectivity to encourage handover of UEs to neighboring cells.

Some embodiments of the method 400 further comprise switching from an active state to an autonomous state responsive to the indication.

Some embodiments of the method 400 further comprise switching from the autonomous state to an inactive state upon expiration of the outage timer.

Some embodiments of the method 400 further comprise switching from the autonomous state to the active state if, prior to expiration of the outage time, connectivity with the BU 30 is re-established.

Some embodiments of the method 400 further comprise stopping generation of the reference signals in the active state.

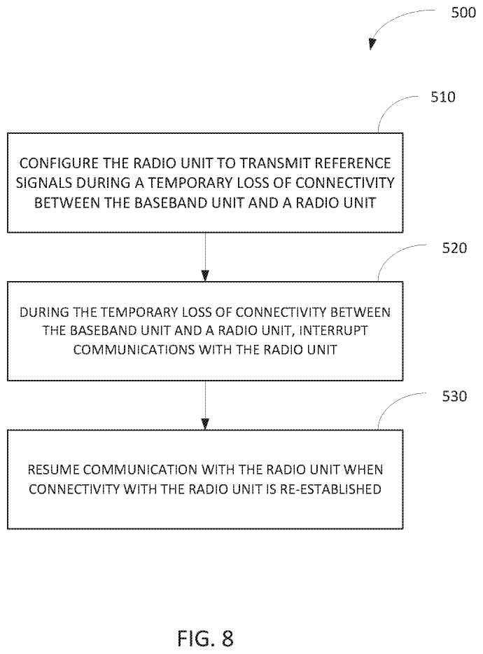

FIG. 8 illustrates an exemplary method 500 of operating a BU 30 in a wireless communication network 10. The BU 30 configures the RU 40 to transmit reference signals during a temporary loss of connectivity between the BU 30 and a RU 40. The BU 30 further interrupts communications with the RU during the temporary loss of connectivity between the BU 30 and a RU 40. The baseband nit 30 further resumes communication with the RU 40 when connectivity with the TU 40 is re-established.

In some embodiments of the method 500, triggering reference signal transmission during the controlled outage period comprises sending a controlled outage notification to the RU 40 including a controlled outage indication.

In some embodiments of the method 500, the controlled outage notification further incudes a time value for an outage timer to indicate a length of the controlled outage period. Some embodiments of the method 500 further comprise restricting new uplink grants after determining the need for a controlled outage.

Some embodiments of the method 500 further comprise temporarily interrupting communications with the RU 40 during the controlled outage period

Some embodiments of the method 500 further comprise continuing limited communication with the RU 40 to complete ongoing HARQ processes before interrupting communications with the RU 40.

Some embodiments of the method 500 further comprise resuming communications with the RU 40 at an end of the controlled outage period.

Some embodiments of the method 500 further comprise ceasing reference signal generation and transmission during the controlled outage period.

Some embodiments of the method 500 further comprise resuming reference signal generation and transmission at the end of the controlled outage period.

Some embodiments of the method 500 further comprise switching from an active state to a controlled outage state responsive to determining a need for a controlled outage.

Some embodiments of the method 500 further comprise switching from the controlled outage state to the active state upon expiration of the outage timer.

Some embodiments of the method 500 further comprise switching from the controlled outage state to the active state prior to expiration of the outage timer when the reason for the controlled outage is resolved.

Some embodiments of the method 500 further comprise resuming the generation and transmission of reference signals for the RU 40 after switching from the controlled outage state to the active state.

Some embodiments of the method 500 further comprise detecting loss of connectivity with the RU 40.

Some embodiments of the method 500 further comprise configuring the RU 40 to transmit reference signals during a temporary loss of connectivity between the BU 30 and a RU 40 comprises configuring an outage timer in the RU 40.

Some embodiments of the method 500 further comprise switching from an active state to a detached state responsive to detecting the loss of connectivity.

Some embodiments of the method 500 further comprise switching from the detached state to an inactive state upon expiration of the outage timer.

Some embodiments of the method 500 further comprise switching from the detached state to the active state if connectivity with the RU 40 is re-established before expiration of the outage timer.

Some embodiments of the method 500 further comprise resuming generation and transmission of the reference signals for the RU 40 after switching from the controlled outage state to the active state.

An apparatus can perform the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

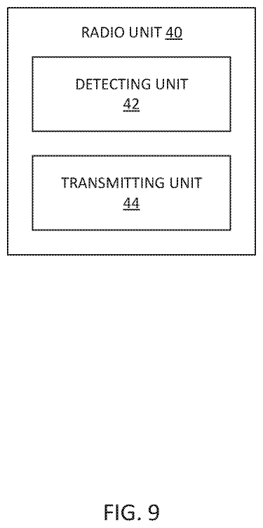

FIG. 9 illustrates an exemplary RU 40 according to one embodiment. The RU 40 comprises a detecting unit 42 and a transmitting unit 44. The various units 42-44 can be implemented by hardware and/or by software code that is executed by one or more processors or processing circuits. The detecting unit 42 is configured to detect an indication of actual or potential loss of connectivity between the RU 40 and a BU 30. The transmitting unit 44 is configured to responsive to the indication, transmit reference signals after the loss of connectivity in order to maintain connection with one or more UEs served by the RU 40 during the loss of connectivity with the BU 30.

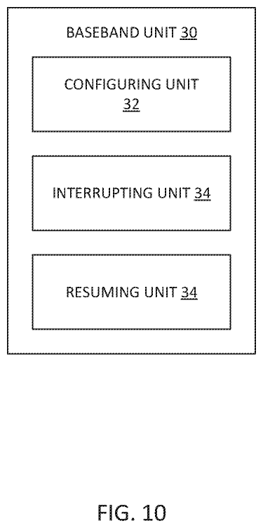

FIG. 10 illustrates an exemplary BU 30 according to one embodiment. The BU 30 comprises a configuring unit 32, an interrupting unit 34, and a resuming unit 36. The various units 32-36 can be implemented by hardware and/or by software code that is executed by one or more processors or processing circuits. The configuring unit 32 is configured to configure the RU 40 to transmit reference signals during a temporary loss of connectivity between the BU 30 and the RU 40. The interrupting unit 34 is configured to, during the temporary loss of connectivity between the BU 30 and the RU 40, interrupt communications with the RU 40. The resuming unit 36 is configured to resume communication with the RU 40 when connectivity with the RU 40 is re-established.

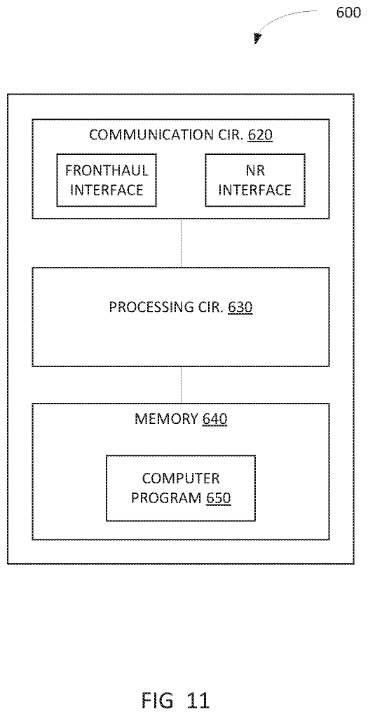

FIG. 11 illustrates an exemplary RU 600 according to one embodiment configured to transmit reference signals during loss of connectivity with the BU 30. The RU 600 comprises communication circuitry 620, a processing circuitry 630, and memory 640.

The communication circuitry 620 includes a fronthaul interface for communicating with the BU and a wireless interface for communicating with UEs over a wireless communication channel. The fronthaul interface may, for example, be configured to operate according to the O-RAN fronthaul specifications. The wireless interface connects to one or more antennas (not shown) and comprises the radio frequency (RF) circuitry for transmitting and receiving signals over a wireless communication channel. The wireless interface may, for example, comprise a transmitter and receiver configured to operate according to the 5G/NR standard.

The processing circuitry 630 controls the overall operation of the RU 600 and processes the signals transmitted to or received by the RU 600. The processing circuitry 630 is configured to perform the methods and processes as herein described including the methods 100, 400 shown in FIGS. 4 and 7, respectively. The processing circuitry 630 may comprise one or more microprocessors, hardware, firmware, or a combination thereof.

In one exemplary embodiment, the processing circuitry is configured detect an indication of actual or potential loss of connectivity between the RU 600 and a BU 30. The processing circuitry 630 is further configured to, responsive to the indication, transmit reference signals after the loss of connectivity in order to maintain connection with one or more UEs served by the RU 40 during the loss of connectivity with the BU 30.

Memory 640 comprises both volatile and non-volatile memory for storing computer program code and data needed by the processing circuitry 630 for operation. Memory 640 may comprise any tangible, non-transitory computer-readable storage medium for storing data including electronic, magnetic, optical, electromagnetic, or semiconductor data storage. Memory 640 stores a computer program 650 comprising executable instructions that configure the processing circuitry 630 to implement the methods and processes as herein described including the methods 100, 400 shown in FIGS. 4 and 7, respectively. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 650 for configuring the processing circuitry 630 as herein described may be stored in a removable memory, such as a portable compact disc, portable digital video disc, or other removable media. The computer program 650 may also be embodied in a carrier such as an electronic signal, optical signal, radio signal, or computer readable storage medium.

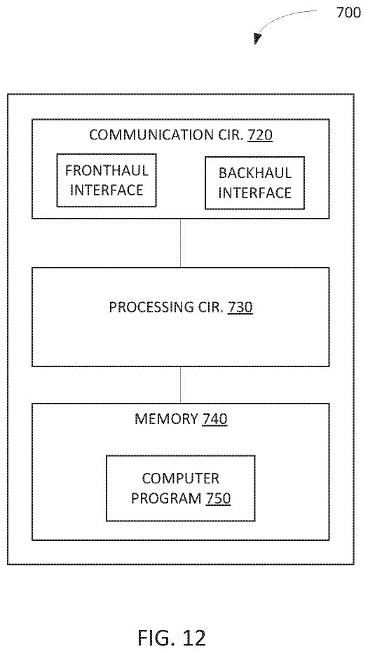

FIG. 12 illustrates an exemplary BU 700 according to one embodiment configured to mitigate loss of connectivity between the BU 30 and RU 40 during a temporary outage. The BU 700 comprises communication circuitry 720, a processing circuitry 730, and memory 740.

The communication circuitry 720 includes a backhaul interface for communication with the core network 20 and a fronthaul interface for communicating with the RU 40. The fronthaul interface may, for example, be configured to operate according to the O-RAN fronthaul specifications.

The processing circuitry 730 controls the overall operation of the BU 700 and processes the signals transmitted to or received by the BU 700. The processing circuitry 730 is configured to perform the methods and processes as herein described including the methods 200, 300 and 500 shown in FIGS. 5, 6 and 8, respectively. The processing circuitry 730 may comprise one or more microprocessors, hardware, firmware, or a combination thereof.

In one exemplary embodiment, the processing circuitry 700 is operative to configure the RU 40 to transmit reference signals during a temporary loss of connectivity between the BU 30 and RU 40, interrupt communications with the RU 40 during the temporary loss of connectivity between the BU 30 and RU 40, and resume communication with the RU 40 when connectivity with the RU 40 is re-established.

Memory 740 comprises both volatile and non-volatile memory for storing computer program code and data needed by the processing circuitry 730 for operation. Memory 740 may comprise any tangible, non-transitory computer-readable storage medium for storing data including electronic, magnetic, optical, electromagnetic, or semiconductor data storage. Memory 740 stores a computer program 750 comprising executable instructions that configure the processing circuitry 730 to implement the methods and processes as herein described including the methods 200, 300 and 500 shown in FIGS. 5, 6 and 8, respectively. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 750 for configuring the processing circuitry 730 as herein described may be stored in a removable memory, such as a portable compact disc, portable digital video disc, or other removable media. The computer program 750 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

FIG. 9 illustrates an exemplary radio unit 40 configured to transmit reference signals during a loss of connectivity with a baseband unit.

FIG. 10 illustrates an exemplary baseband unit 30 configured to mitigate loss of connectivity with a radio unit.

FIG. 11 illustrates an exemplary radio unit 600 configured to transmit reference signals during a loss of connectivity with a baseband unit.

FIG. 12 illustrates an exemplary baseband unit 700 configured to mitigate loss of connectivity with a radio unit.

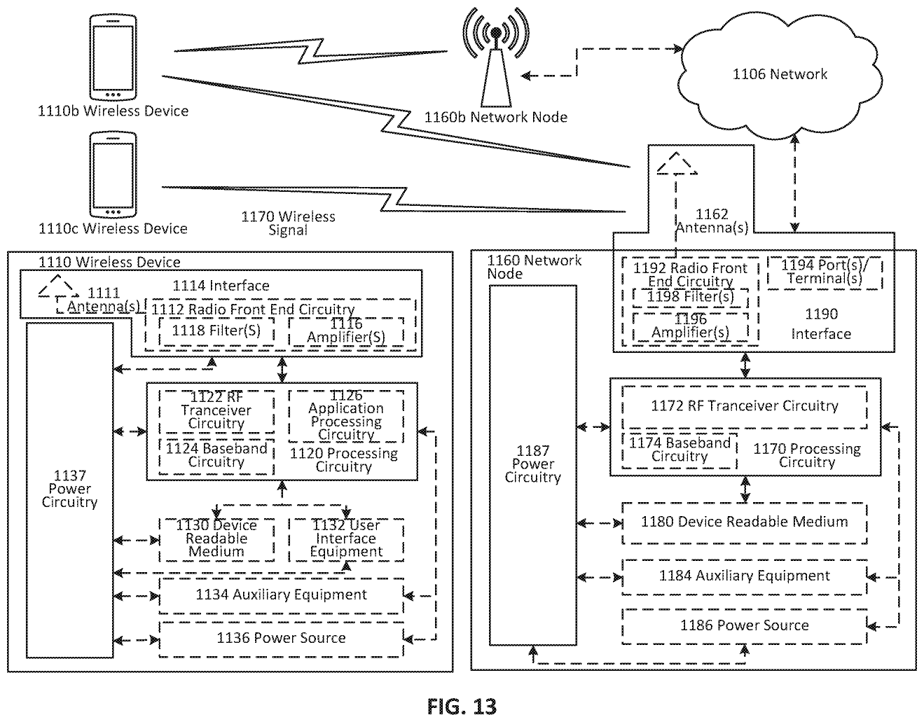

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 13 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WIMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

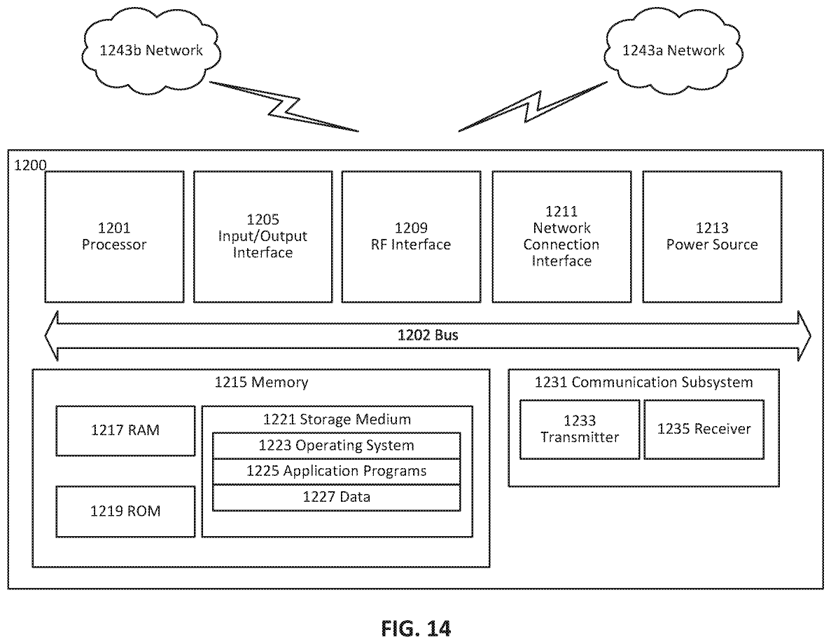

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3rd Generation Partnership Project (3GPP), including a NB-IoT UE, a machine type communication (MTC) UE, and/or an enhanced MTC (eMTC) UE. UE 1200, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 14, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.13, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

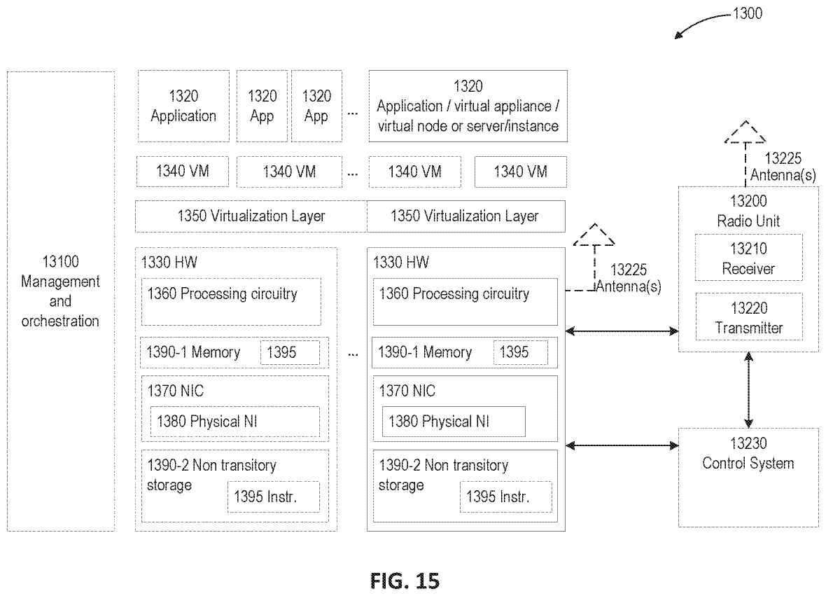

FIG. 15 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 15, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 15.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

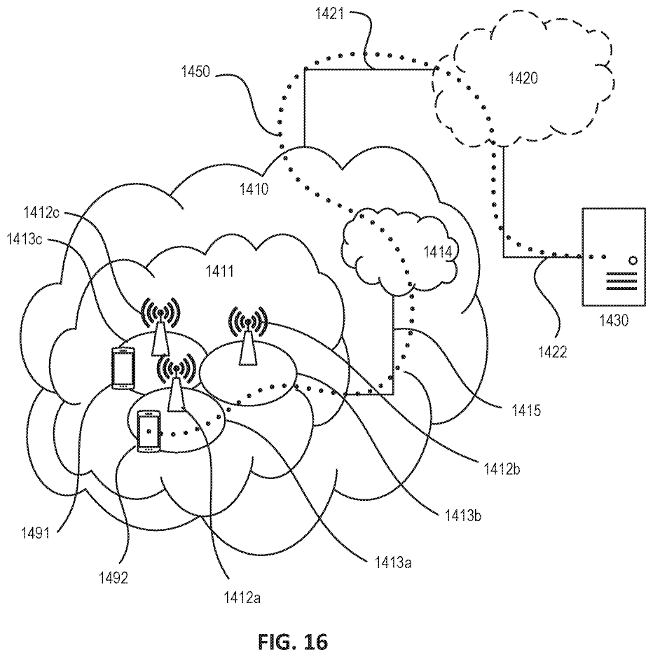

FIG. 16 illustrates a telecommunication network connected via an intermediate network to a host computer in accordance with some embodiments. In particular, with reference to FIG. 16, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

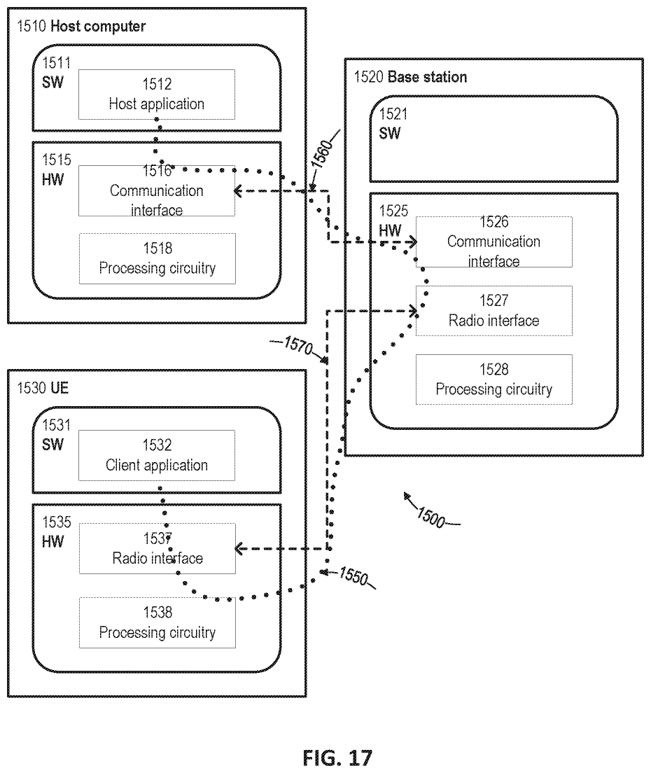

The communication system of FIG. 17 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

Example implementations, in accordance with an embodiment, of the UE, base station and host computer discussed in the preceding paragraphs will now be described with reference to FIG. 17. FIG. 17 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

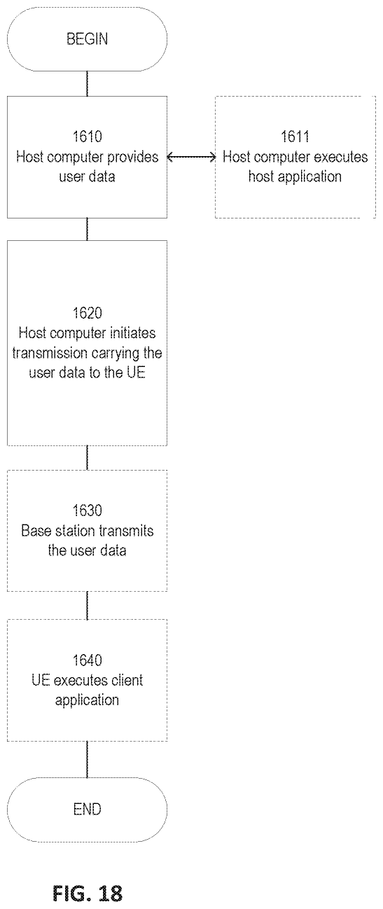

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 18) served by base station 1520. Communication interface 1526 may be configured to facilitate connection 1560 to host computer 1510. Connection 1560 may be direct or it may pass through a core network (not shown in FIG. 17) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 17 may be similar or identical to host computer 1430, one of base stations 1412a, 1412b, 1412c and one of UEs 1491, 1492 of FIG. 16, respectively. This is to say, the inner workings of these entities may be as shown in FIG. 17 and independently, the surrounding network topology may be that of FIG. 16.

In FIG. 17, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve the NAS security and latency and thereby provide benefits such as improved user experience and robustness of user communications.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

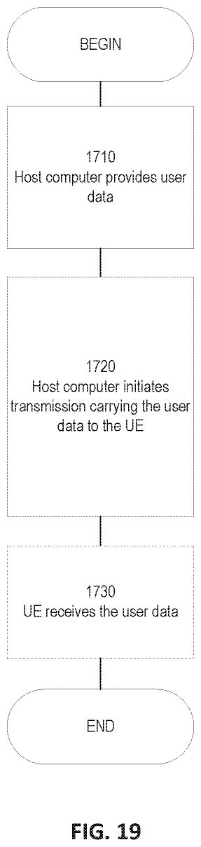

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

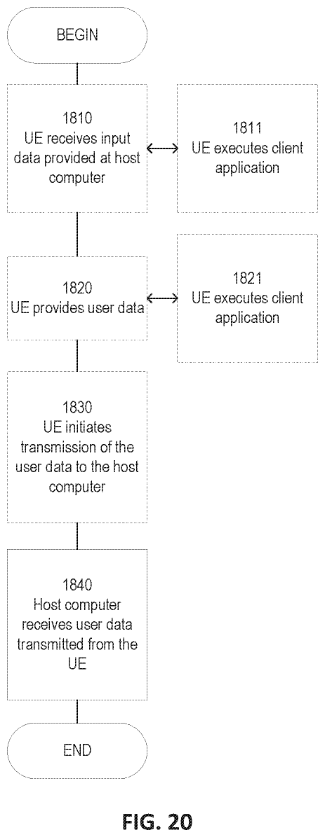

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

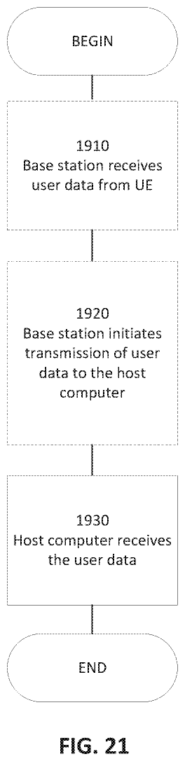

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1-57. (canceled)

58. A method of operating a radio unit in a wireless communication network, the method comprising:
detecting an indication of actual or potential loss of connectivity between the radio unit and a baseband unit; and
responsive to the indication, transmitting reference signals after the loss of connectivity in order to maintain connection with one or more user equipment (UEs) served by the radio unit during the loss of connectivity with the baseband unit.

59. The method of claim 58, wherein detecting the indication comprises detecting an unplanned loss of connectivity with the baseband unit.

60. The method of claim 59, further comprising generating the reference signals until connectivity with the baseband unit is re-established.

61. The method of claim 59, further comprising:
initiating an outage timer responsive to the unplanned loss of connectivity; and
generating the reference signals until the outage timer expires.

62. The method of claim 58, wherein the indication is received in a control message prior to a planned loss of connectivity with the baseband unit.

63. The method of claim 62, further comprising:
initiating an outage timer responsive to the control message; and
generating the reference signals until the outage timer expires.

64. The method of claim 58, further comprising:
storing PRACH signals in a PRACH buffer and/or storing PUCCH signals in a PUCCH buffer and/or storing PUSCH signals in a PUSCH buffer.

65. The method of claim 58, further comprising decreasing transmit power of the reference signals during the loss of connectivity to encourage handover of UEs to neighboring cells.

66. The method of claim 58, further comprising switching from an active state to an autonomous state responsive to the indication.

67. A method of operating a baseband unit in a radio access network, the method comprising:
configuring the radio unit to transmit reference signals during a temporary loss of connectivity between the baseband unit and the radio unit; and
during the temporary loss of connectivity between the baseband unit and the radio unit, interrupting communications with the radio unit; and
resuming communication with the radio unit when connectivity with the radio unit is re-established.

68. The method of claim 67, further comprising:
determining a need for a controlled outage that will result in the temporary loss of connectivity between the baseband unit and a radio unit; and
responsive to the determining the need for the controlled outrage period, triggering reference signal transmission by the radio unit during a controlled outage period.

69. The method of claim 68, wherein triggering reference signal transmission during the controlled outage period comprises sending a controlled outage notification to the radio unit including a controlled outage indication.

70. The method of claim 69, wherein the controlled outage notification further incudes a time value for an outage timer to indicate a length of the controlled outage period.

71. The method of claim 68, further comprising switching from an active state to a controlled outage state responsive to determining a need for a controlled outage.

72. The method of claim 67, further comprising detecting loss of connectivity with the radio unit.

73. The method of claim 72, further comprising switching from an active state to a detached state responsive to detecting the loss of connectivity.

74. A radio unit in a wireless communication network, the radio unit comprising:
communication circuitry including a wireless interface to communicate with one or more user equipment (UE) in the wireless communication network and a fronthaul interface to communicate with a baseband unit; and
processing circuitry configured to:
detect an indication of actual or potential loss of connectivity between the radio unit and a baseband unit; and
responsive to the indication, transmit reference signals after the loss of connectivity in order to maintain connection with one or more user equipment (UEs) served by the radio unit during the loss of connectivity with the baseband unit.

75. A baseband unit in a wireless communication network, the baseband unit comprising:
communication circuitry including a fronthaul interface to communicate with a radio unit; and
processing circuitry configured to:
configure the radio unit to transmit reference signals during a temporary loss of connectivity between the baseband unit and the radio unit; and
during the temporary loss of connectivity between the baseband unit and the radio unit, interrupt communications with the radio unit; and
resume communication with the radio unit when connectivity with the radio unit is re-established.
